(19) United States
(12) Patent Application Publication
(10) Pub. No.: US 2019/0114375 A1
(43) Pub. Date: Apr. 18, 2019

(54) THREE-DIMENSIONAL MODEL DESIGN SYSTEM, METHOD, AND PROGRAM

(71) Applicant: OPTiM Corporation, Saga-shi (JP)

(72) Inventor: Shunji SUGAYA, Tokyo (JP)

(21) Appl. No.: 16/088,937

(22) PCT Filed: Mar. 30, 2016
(86) PCT No.: PCT/JP2016/060338

§ 371 Date: Sep. 27, 2018

(51) Int. Cl. G06F 17/50; G06T 17/05

(52) U.S. Cl. CPC G06F 17/5004; G06T 17/05

(57) ABSTRACT

A positional relationship between a construction and an installation place can be easily grasped in a design stage. A 3D model design system includes a section information acquiring unit that acquires latitude and longitude information of a section where a construction is to be installed, a design unit that designs a 3D model design object of the construction, a size calculating unit that calculates a size of the designed 3D model design object, and a latitude/longitude assigning unit that assigns latitude and longitude information to the 3D model design object based on the calculated size.

### TECHNICAL FIELD

The present invention relates to a 3D (Three-Dimensional) model design system, method, and program.

### BACKGROUND ART

In recent years, a 3D model design system is used for designing buildings. Patent Document 1 discloses a cooperative map display device capable of easily grasping a positional relationship of a plurality of drawings by linking a map and the drawings.

### PRIOR ART DOCUMENT

### Patent Document

Patent Document 1: Japanese Patent Application Publication No. 2003-162729

### SUMMARY OF THE INVENTION

### Technical Problem

Conventionally, a 3D model design object created on the 3D model design system is not given information on a position of an installation place of a construction to be constructed based on the 3D model design object. For this reason, it is difficult to grasp a positional relationship between the construction and the installation place at a design stage by the 3D model design system.

Accordingly, an object of the present invention is to provide a 3D model design system, method, and program capable of easily grasping the positional relationship between the construction and the installation place at the design stage.

### Technical Solution

A 3D model design system according to an embodiment includes a section information acquiring unit that acquires latitude and longitude information of a section where a construction is to be installed, a design unit that designs a 3D model design object corresponding to the construction, a size calculating unit that calculates a size of the designed 3D model design object, and a latitude/longitude assigning unit that assigns latitude and longitude information to the 3D model design object based on the calculated size.

The 3D model design system may further include a section shape acquiring unit that acquires a shape of the section. The latitude/longitude assigning unit may assign the latitude and longitude information to the 3D model design object based on the acquired latitude and longitude information and the acquired shape of the section.

The section information acquiring unit may latitude and longitude information of a central portion or one or more edge portions of the acquired shape of the section.

The 3D model design system may further include an input unit that accepts designation of a coordinate located on the 3D model design object. The latitude/longitude assigning unit may assign latitude and longitude information to the designated coordinate on the 3D model design object.

The 3D model design system may further include a display unit that displays the latitude and longitude information assigned to the designated coordinate on the 3D model design object together with the 3D model design object.

### Effects of the Invention

According to the present invention, it is possible to easily grasp a positional relationship between a construction and an installation place, at the design stage.

### BRIEF DESCRIPTION OF THE DRAWINGS

FIG. 1 is a diagram for explaining an overview of the present embodiment.

FIG. 2 shows a configuration example of a 3D model design system.

FIG. 3 shows a configuration example of a section management table.

FIG. 4 shows a configuration example of a coordinate management table.

FIG. 5 is a flowchart showing an example of a process of creating a 3D model design object.

### DETAILED DESCRIPTION OF THE EMBODIMENTS

Hereinafter, embodiments for carrying out the present invention are described with reference to the drawings. It is to be understood that the embodiments are merely examples and the scope of the present invention is not limited to the disclosed embodiments.

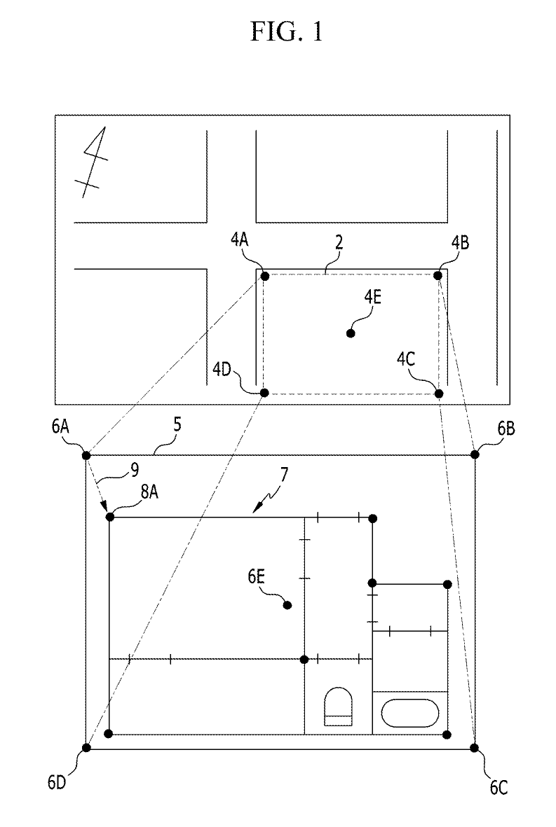

FIG. 1 is a diagram for explaining an overview of the present embodiment.

A 3D model design system is a computer system that assists a user in designing a construction. In the present embodiment, one designed by the 3D model design system is referred to as a “3D model design object”. A construction and the 3D model design object are not limited to a structure such as a house or a building, and may be, for example, an object captured by a camera, a playground such as a park or an amusement park, or anything which is designed in the 3D model design system. Further, the 3D model design object designed in the 3D model design system may be either two-dimensional or three-dimensional. A two-dimensional 3D model design object may be a drawing or a floor plan.

The 3D model design system may acquire information (hereinafter referred to as “section information”) on a place (section) where a construction is to be installed. The section information may include information (hereinafter referred to as “latitude and longitude information”) on a position of a section and/or information (hereinafter referred to as “section shape information”) on a shape of the section.

As shown in FIG. 1, a design region 5 corresponding to a section 2 may be displayed in a screen of the 3D model design system. In FIG. 1, the section shape information of the section 2 is “rectangular”, and the 3D model design system compares latitude and longitude information 4A, 4B, 4C, and 4D of respective vertices of the section 2 with coordinates 6A, 6 B, 6 C, and 6D of respective vertices of the design region 5, respectively. The 3D model design system may associate latitude and longitude information on an edge of the section 2 with a coordinate on an edge of the design region 5. Further, the 3D model design system may associate latitude and longitude 4E at a center of the section 2 with a coordinate 6E at a center of the design region 5.

The 3D model design object 7 corresponding to the construction to be installed in the section 2 may be displayed in the design area 5.

A user of the 3D model design system may be able to designate an arbitrary coordinate of the 3D model design object 7 of which the user wants to know latitude and longitude information. The 3D model design system may calculate the latitude and longitude information corresponding to the coordinate designated on the 3D model design object 7 based on a size of the 3D model design object 7. For example, when a coordinate 8A on the 3D model design object 7 are designated by the user, the 3D model design system may calculate the latitude and longitude information corresponding to the coordinate 8A, using latitude and longitude information 4A associated with a coordinate 6A relatively close to the coordinate 8A and a value obtained by converting a vector 9 from the coordinate 6A to the coordinate 8A into an actual size.

The 3D model design system may display the latitude and longitude information corresponding to the designated coordinate 8A on the screen. Accordingly, for the arbitrary coordinate on the 3D model design object 7, the user can easily know the longitude and latitude information in a case where the construction corresponding to the 3D model design object 7 is installed in the section 2. Therefore, the user can easily grasp the positional relationship between the construction and the section at the design stage.

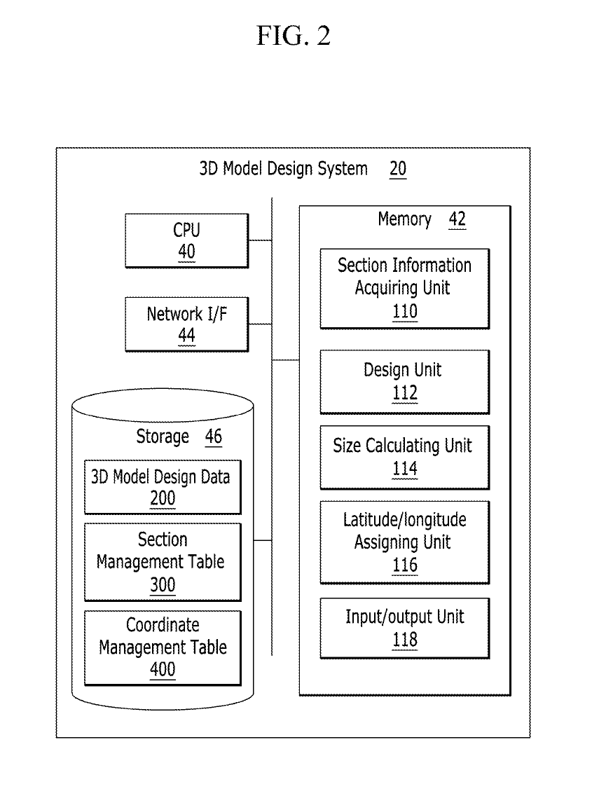

FIG. 2 shows a configuration example of the 3D model design system 20.

A 3D model design system 20 may include, as hardware, a CPU 40, a memory 42, a storage 46, and a network I/F 44, and an internal bus 48 interconnecting these devices.

The network I/F 44 controls data to be exchanged with other devices via a predetermined communication network. The network I/F 44 may be either a wired I/F or a wireless I/F. The network I/F 44 may be, for example, an NIC (network interface card).

The CPU 40 executes programs stored in the memory 42, thereby realizing various functions of the 3D model design system 20.

The programs and data for realizing the functions of the 3D model design system 20 are stored in the memory 42. The memory 42 is, for example, DRAM (dynamic random access memory), SRAM (static random access memory), or the like.

A section information acquiring unit 110, a design unit 112, a size calculating unit 114, a latitude/longitude assigning unit 116, and an input/output unit 118 may be stored, as programs, in the memory 42. These programs may be stored in the storage 46 and appropriately read into the memory 42. The explanation of each program is described later.

The programs and/or data used in the 3D model design system 20 are stored in the storage 46. The storage 46 is, for example, an HDD (hard disk drive), an SSD (solid state drive), or the like. In the storage 46, 3D model design data 200, a section management table 300, and a coordinate management table 400 may be stored as the data.

The 3D model design data 200 are data relating to a 3D model design object (two-dimensional drawing data, three-dimensional model data, etc.). The 3D model design data 200 may be created by the design unit 112.

Next, the section management table 300 and the coordinate management table 400 is described.

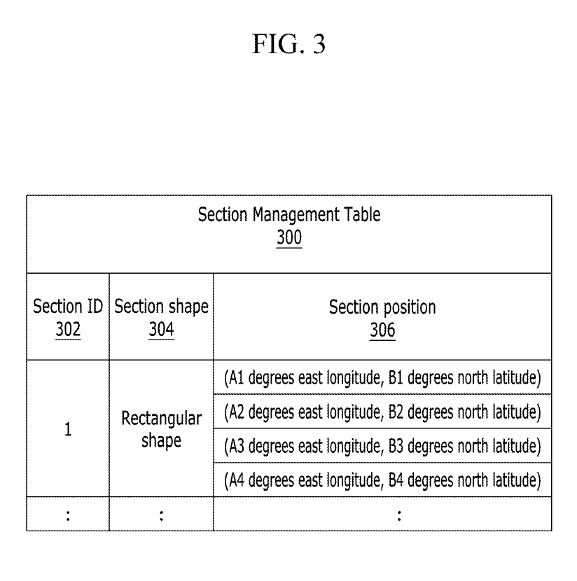

FIG. 3 shows a configuration example of a section management table 300.

A section management table 300 manages information (section information) on a section where a construction is installed. The section management table 300 may include a section ID 302, a section shape 304, and a section position 306 as data items.

A identifier of a section is stored in the section ID 302.

Section shape information of the section ID 302 is stored in the section shape 304. For example, a rectangular shape, a trapezoidal shape, a polygonal shape, a flagpole shape, an elliptical shape, or the like may be stored in the section shape 304.

At least one piece of latitude and longitude information included in the section of the section ID 302 is stored in the section position 306. Latitude and longitude information on a vertex, a center point or an edge of the section of the section ID 302 may be stored in the section position 306. When the section shape 304 is the polygonal shape, the latitude and longitude information on each vertex of the polygon may be stored in the section position 306. When the section shape 304 is the elliptical shape, the latitude and longitude information on a center point, both ends of a long axis, and both ends of a short axis in the ellipse may be stored in the section position 306.

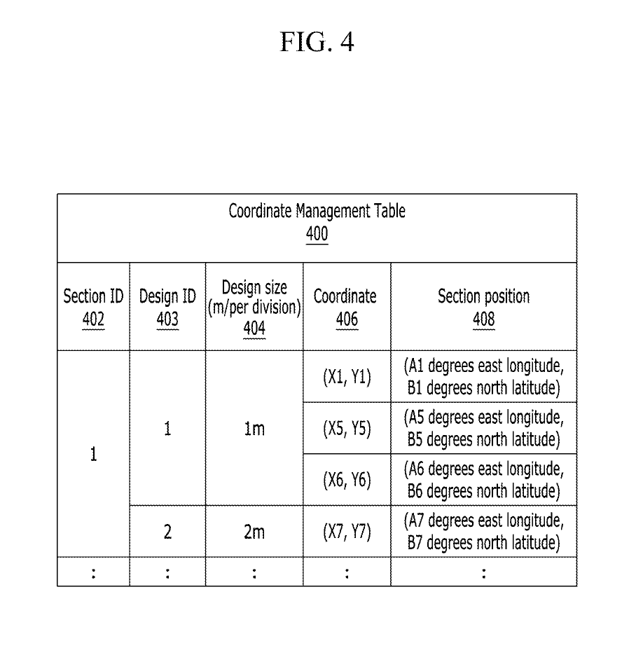

FIG. 4 shows a configuration example of a coordinate management table 400.

A coordinate management table 400 manages a correspondence relationship between a coordinate on the 3D model design object and actual latitude and longitude information in a case where a construction corresponding to the 3D model design object is installed in a section. The coordinate management table 400 may include a section ID 402, a design ID 403, a design size 404, a coordinate 406, and a section position 408 as data items.

Any one of the section IDs 302 of the section management table 300 is stored in the section ID 402.

An identifier of a 3D model design corresponding to a construction installed in a section of the section ID 402 is stored in the design ID 403. When a plurality of constructions are installed in one section, a plurality of design IDs 403 may be associated with the one section ID 402.

In the design size 404, for example, an actual size per division on a design region displayed by the 3D model design system 20 are stored.

A coordinate on the 3D model design of the design ID 403 is stored in the coordinate 406. A coordinate designated by the user may be stored in the coordinate 406.

Latitude and longitude information corresponding to the coordinate 406 is stored in the section position 408.

The example shown in FIG. 4 shows that the coordinate 406 (X1, Y1) correspond to the section position 408 (A1 degrees east longitude, B1 degrees north latitude).

It is returned to the explanation of FIG. 2.

The section information acquiring unit 110 acquires section information. The section information may include section shape information, and latitude and longitude information. A unit for acquiring the section shape information may be referred to as a “section shape acquiring unit”. The section information acquiring unit 110 may store the acquired section information in the section management table 300. The section information acquiring unit 110 may acquire the section information by any means. For example, the section information acquiring unit 110 may download the section information from a predetermined server or may read from a predetermined recording medium (a USB memory, a DVD, etc.).

The design unit 112 provides a function (i.e., a function of a 3D model design) for assisting the user to create the 3D model design.

The size calculating unit 114 calculates a size (a design size) of the 3D model design object and stores the size in the design size 404 of the coordinate management table 400.

On the basis of the size calculated by the size calculating unit 114, the latitude/longitude assigning unit 116 assigns latitude and longitude information to the 3D model design object, for example, as follows. That is, the latitude/longitude assigning unit 116 may calculate the latitude and longitude information corresponding to the coordinate on the 3D model design, using the section position 306 and the design size 404 of the section management table 300. The latitude/longitude assigning unit 116 may store the coordinate on the 3D model design object and the calculated latitude and longitude information in the coordinate management table 400 in association with each other. If the correspondence relationship between a coordinate of at least one point and latitude and longitude information is known, latitude and longitude information may be calculated for other coordinates on the 3D model design by conversion according to the design size 404.

The input/output unit 118 accepts an operation relating to creation of the 3D model design object from the user, or displays a GUI or the like relating to the 3D model design object or the operation on the screen.

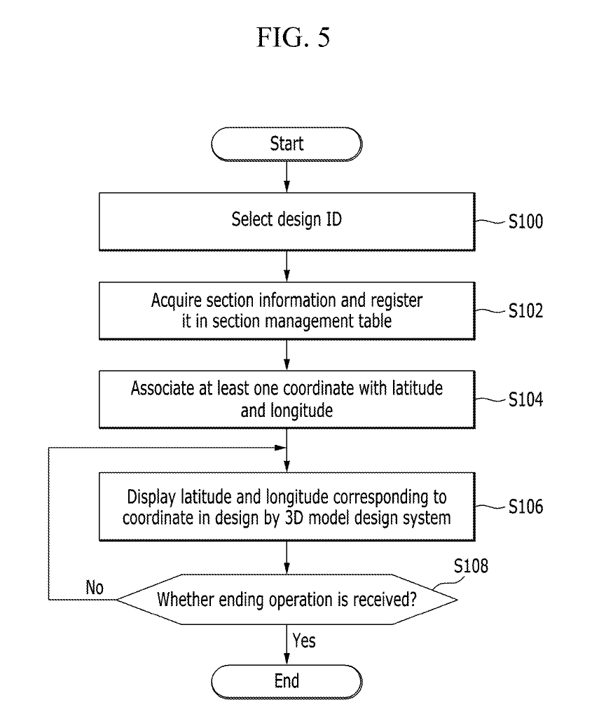

FIG. 5 is a flowchart showing an example of a process of creating a 3D model design object.

A user selects a design ID 403 of a 3D model design object to be created or edited (step S100). The design ID 403 selected by the user is referred to as a “selected design ID” in the description of this figure.

A section information acquiring unit 110 acquires section information of a section ID 402 corresponding to the selected design ID and registers the section information in the section management table 300 (step S102).

A latitude/longitude assigning unit 116 registers at least one piece of coordinate and latitude and longitude information relating to the selected design ID in the coordinate management table 400 (step S104). For example, when the user selects a coordinate of one point from a 3D model design object and latitude and longitude information of one point from a section through an input/output unit 118, the latitude/longitude assigning unit 116 may associate the selected coordinate and latitude and longitude information with each other.

A design unit 112 displays a GUI for creating the 3D model design object or the 3D model design object on a screen, in cooperation with the input/output unit 118. The user may manipulate the GUI to create the 3D model design object. At this time, when the user designates a coordinate on the 3D model design object, the latitude/longitude assigning unit 116 may calculate and display the latitude and longitude information corresponding to the designated coordinate (step S106). Furthermore, the latitude/longitude assigning unit 116 may register the designated coordinate and the calculated latitude and longitude information in the coordinate management table 400 in association with each other.

Upon receiving an operation of ending the creation of the 3D model design object from the user (step S108: YES), the design means 112 ends the present process.

According to the above processing, the user can easily know the latitude and longitude information of a case where the construction corresponding to the 3D model design object is installed in the section, in a stage of creating the 3D model design object.

The above-described embodiments are examples for explaining the present invention, and the scope of the present invention is not limited to the embodiments. Those skilled in the art can implement the present invention in various other embodiments without departing from the scope of the present invention.

### DESCRIPTION OF REFERENCE NUMBERS

20: 3D model design system 110, 110: section information acquiring unit 112, 112: design unit, 114: size calculating unit, 116: latitude/longitude assigning unit, 118: input/output unit, 200: 3D model design data, 300: section management table, 400: coordinate management table

1. A 3D model design system comprising:
a section information acquiring unit that acquires latitude and longitude information of a section where a construction is to be installed;
a design unit that designs a 3D model design object of the construction;
a size calculating unit that calculates a size of the designed 3D model design object;
a latitude/longitude assigning unit that assigns latitude and longitude information to the 3D model design object based on the calculated size; and
an input unit that accepts designation of a coordinate located on the 3D model design object,
wherein the latitude/longitude assigning unit assigns latitude and longitude information to the designated coordinate located on the 3D model design object, based on a value obtained by converting a vector from a coordinate of a neighborhood whose latitude and longitude has been calculated to the designated coordinate to an actual size.

2. The 3D model design system according to claim 1, further comprising a section shape acquiring unit that acquires a shape of the section,
wherein the latitude/longitude assigning unit assigns the latitude and longitude information to the 3D model design object based on the acquired latitude and longitude information and the acquired shape of the section.

3. The 3D model design system according to claim 2, wherein the section information acquiring units acquires latitude and longitude information of a central portion or one or more edge portions of the acquired shape of the section.

4. (canceled)

5. The 3D model design system according to claim 1, further comprising a display unit that displays the latitude and longitude information assigned to the designated coordinate on the 3D model design object together with the 3D model design object.

6. A 3D model design method comprising:
a section information acquiring step of acquiring latitude and longitude information of a section where a construction is to be installed;
a design step of designing a 3D model design object of the construction;
a size calculating step of calculating a size of the designed 3D model design object;
a latitude and longitude assigning step of assigning latitude and longitude information to the 3D model design object based on the calculated size; and
an input unit that accepts designation of a coordinate located on the 3D model design object,
wherein the latitude and longitude assigning step assigns latitude and longitude information to the designated coordinate located on the 3D model design object, based on a value obtained by converting a vector from a coordinate of a neighborhood whose latitude and longitude has been calculated to the designated coordinate to an actual size.

7. A program for causing a 3D model design method to execute:
a section information acquiring step of acquiring latitude and longitude information of a section where a construction is to be installed;
a design step of designing a 3D model design object of the construction;
a size calculating step of calculating a size of the designed 3D model design object;
a latitude and longitude assigning step of assigning latitude and longitude information to the 3D model design object based on the calculated size; and
an input unit that accepts designation of a coordinate located on the 3D model design object,
wherein the latitude and longitude assigning step assigns latitude and longitude information to the designated coordinate located on the 3D model design object, based on a value obtained by converting a vector from a coordinate of a neighborhood whose latitude and longitude has been calculated to the designated coordinate to an actual size.
